(19) United States
(12) Patent Application Publication
(10) Pub. No.: US 2009/0208220 A1
(43) Pub. Date: Aug. 20, 2009

(54) Systems and methods for generating RF pulses with reduced phase error

(75) Inventor: Michael J. Lagasse, Nahant, MA (US)

Correspondence Address: OPTICUS IP LAW, PLLC, 7791 ALISTER MACKENZIE DRIVE, SARASOTA, FL, 34240, US

(73) Assignee: MAGIQ TECHNOLOGIES, INC.

(21) Appl. No.: 12/322,379

(22) Filed: Feb. 2, 2009

Related U.S. Application Data
(60) Provisional application No. 61/065,996, filed on Feb. 15, 2008.

(51) Int. Cl. H04B 10/00

(52) U.S. Cl. 398/115

(57) ABSTRACT

Systems and methods for generating RF pulses that have a reduced phase error are disclosed. The systems are optical based and thus are highly linear, so that phase errors, including jitter, are significantly reduced as compared to electrical RF pulse generation systems and methods. The optical-based RF pulse generation methods includes generating laser light, imparting an envelope modulation to the laser light, imparting a carrier modulation to the laser light, and detecting the envelope-modulated and carrier-modulated light to form the electrical RF pulse. The electrical RF pulse can then be carried by a cable to an external device.

### CLAIM OF PRIORITY

This application claims the benefit of priority under 35 U.S.C. § 119(e) of U.S. Provisional Application Ser. No. 61/065,996 filed on Feb. 15, 2008, which application is incorporated by reference herein.

### FIELD OF THE INVENTION

The present invention relates generally to radio-frequency (RF) signals, and in particular to the generation of RF signals in the form of pulses that have small phase error.

### BACKGROUND ART

Pulsed RF signals are used in a variety of applications from distance measurement systems to magnetic resonant imaging (MRI) systems to quantum computers. For many applications, the RF pulses can have relatively large phase errors (e.g., up to 10°) and still achieve their purpose. However, for certain applications such as quantum computing and MRI systems, the phase errors need to be as small as possible, in some cases as low as 1° or even 0.1°.

Pulsed RF signals are typically generated by using two orthogonal baseband signals. One signal is an in-phase signal (the “I signal”), and the other signal is a quadrature-phase signal (the “Q signal”). The I and Q baseband signals are converted to a bandpass signal by a device called an “IQ mixer.” The IQ mixer modulates the I signal with an in-phase carrier, and modules the Q signal with a quadrature-phase carrier. The modulated signals are summed together to form a bandpass signal in the form of an RF pulse.

One of the problems with IQ mixers is that they tend to generate phase errors in the modulation process. These phase errors arise due to a number of factors, including nonlinearities in the electronic components, and path length mismatches that arise when the IQ mixer is fabricated. In the case where the phase errors are random or quasi-random, they represent a source of jitter in the RF pulse.

While for many applications phase errors can be considered negligible, for other applications the phase errors are unacceptable. And while the phase errors can be reduced by electronic means, some applications such as quantum computing require a degree of phase precision that is not readily obtainable through electronic compensation schemes.

### SUMMARY OF THE INVENTION

The present invention relates generally to radio-frequency (RF) signals, and in particular to the generation of RF signals in the form of pulses that have very low phase errors, including random and quasi-random phase errors that cause jitter.

One aspect of the invention is a RF pulse generator system. The system includes a laser that emits laser light, and a first optical modulator arranged to receive the laser light. The first modulator is configured to impart to the received laser light one of an envelope modulation and a carrier modulation. The system also includes a second optical modulator arranged downstream of the first optical modulator so as to receive the laser light from the first modulator. The second modulator is configured to impart to the laser light therefrom the other of the carrier modulation and the envelope modulation imparted by the first modulator so as to form an optical RF pulse. The system also includes a photodetector arranged to receive and detect the optical RF pulse from the second modulator and form a corresponding RF electrical pulse.

Another aspect of the invention is a RF pulse generator system that includes a laser that emits laser light. The system also includes an optical modulator arranged to receive the laser light and configured to impart to the received laser light one of an envelope modulation and a carrier modulation. The system also includes an envelope-modulation generator operably connected to one of the laser and the optical modulator and configured to generate an envelope-modulation signal that drives one of the laser and the optical modulator with the envelope modulation. The system further includes a carrier-modulation generator operably connected to the other of the laser and the optical modulator and configured to generate a carrier modulation signal that drives with the carrier modulation the other of the laser and the optical modulator driven by the envelope-modulation generator so that the laser light exiting the optical modulator includes an envelope modulation and a carrier modulation that forms an optical RF pulse. The system also includes a photodetector arranged to receive the optical RF pulse and form therefrom an electrical RF pulse.

Another aspect of the invention is a method of generating an electrical RF pulse. The method includes generating laser light with a laser, and imparting an envelope modulation to the laser light. The method also includes imparting a carrier modulation to the laser light. The method further includes detecting the envelope-modulated and carrier-modulated light to form the electrical RF pulse. The method can also include modulating the laser directly with an envelope-modulation signal or a carrier-modulation signal so that the light exiting the laser is already modulated. The remaining modulation is then applied to the laser light to form the optical RF pulse. The extinction of the optical RF pulse and thus the subsequent electrical RF pulse can be enhanced by applying the envelope modulation to the laser and then again after an optical modulator imparts the carrier modulation.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a schematic diagram of a first example embodiment of the RF pulse generator system that uses first and second optical modulators for imparting carrier modulation and envelope modulation;

FIG. 2 is a schematic diagram of a second example embodiment of the RF pulse generator system that uses a single optical modulator for imparting the carrier modulation while directly envelope-modulating the laser;

FIG. 3 is a schematic diagram of a third example embodiment of the RF pulse generator system that uses a single optical modulator for imparting the envelope modulation while the laser is directly carrier-modulated; and

FIG. 4 is a schematic diagram of a third example embodiment of the RF pulse generator system that uses respective optical modulators for imparting the carrier modulation and the envelope modulation, while the laser is also directly envelope-modulated.

### DETAILED DESCRIPTION OF THE INVENTION

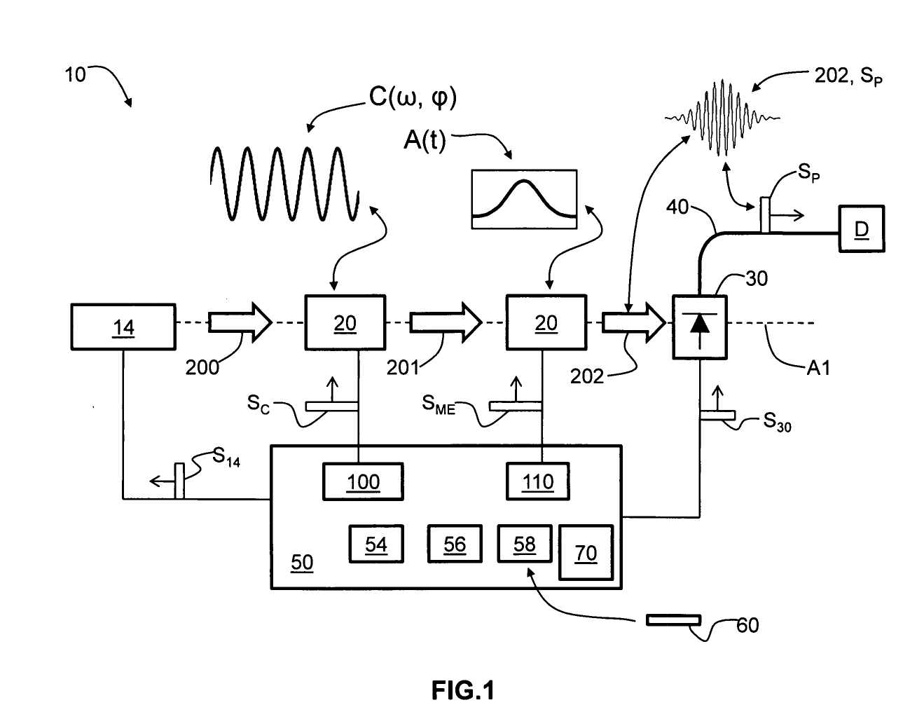

FIG. 1 is a schematic diagram of a first example embodiment of an RF pulse generator system 10. System 10 includes a laser 14, such as a semiconductor laser or a diode-pumped Nd:YAG laser. Laser 14 is arranged along an optical axis Al and is optically coupled to a first optical modulator 20, which in turn is optical coupled to a second modulator 20 arranged in order along optical axis Al. In an example embodiment, modulators 20 are or otherwise include lithium-niobate modulators or like optical modulators.

A photodetector 30 is arranged along optical axis Al downstream of the second optical modulator and is optically coupled thereto. An electrical cable 40, such a coaxial cable, is electrically connected to photodetector 30.

System 10 further includes a controller 50 operably connected to laser 14 and the first and second modulators 20, and optionally to photodetector 30. In an example embodiment controller 50 is or includes a programmable computer with a processor 54 and includes an operating system such as Microsoft WINDOWS or LINUX. In an example embodiment, controller 50 may also be or otherwise include an analog circuit with feedback, or analog and digital circuits that provide a combination of analog and digital control.

In an example embodiment, processor 54 is or includes any processor or device capable of executing a series of software instructions and includes, without limitation, a general- or special-purpose microprocessor, finite state machine, controller, computer, central-processing unit (CPU), field-programmable gate array (FPGA), or digital signal processor. In an example embodiment, the processor is an Intel XEON or PENTIUM processor, or an AMD TURION or other in the line of such processors made by AMD Corp., Intel Corp. or other semiconductor processor manufacturer.

Controller 50 also preferably includes a memory unit (“memory”) 56 operably coupled to processor 54. As used herein, the term “memory” refers to any processor-readable (or “computer-readable”) medium, including but not limited to RAM, ROM, EPROM, PROM, EEPROM, disk, floppy disk, hard disk, CD-ROM, DVD, or the like, on which may be stored a series of instructions (e.g., the aforementioned software) executable by processor 54. In an example embodiment, controller 50 includes a drive or port 58 (e.g., a disk drive or USB port) adapted to accommodate a removable processor-readable medium 60, such as CD-ROM, DVE, memory stick or like storage medium.

The methods of the present invention may be implemented in various embodiments in a machine-readable medium (e.g., memory 56) comprising machine readable instructions (e.g., computer programs and/or software modules) for causing controller 50 to perform the methods and the controlling operations for operating system 10. The computer programs and/or software modules may comprise multiple modules or objects to perform the various methods of the present invention, and control the operation and function of the various components in system 10. The type of computer programming languages used for the code may vary between procedural code type languages to object oriented languages. The files or objects need not have a one to one correspondence to the modules or method steps described depending on the desires of the programmer. Further, the method and apparatus may comprise combinations of software, hardware and firmware. Firmware can be downloaded into processor 54 for controlling the operation of system 10 and for generally implementing the various example embodiments of the invention.

Controller 50 also optionally includes a display 70 that can be used to display information using, for example, a wide variety of alphanumeric and graphical representations.

Controller 50 also includes a carrier-signal generator 100 that generates an electrical RF carrier signal S_{C} and that is electrically connected to the first optical modulator 20. Controller 50 also includes an envelope-modulation signal generator 110 that generates an envelope-modulation signal S_{ME} and that is electrically connected to the second optical modulator 20.

In operation, controller 50 generates a laser control signal S₁₄ that causes laser 14 to generate laser light 200 at a given wavelength λ. Laser light 200 travels along optical axis A1 to first modulator 20. Meanwhile, controller 50 causes carrier-signal generator 100 therein to generate carrier signal S_{C} with an associated carrier frequency ω and phase φ. This signal drives the first optical modulator 20 so as to modulate laser light 200 with the RF carrier signal, thereby forming once-modulated RF-modulated laser light 201 having the same carrier frequency ω and phase φ as the electrical carrier signal S_{C}. The associated carrier wave C(ω, φ) is shown in FIG. 1.

Meanwhile, controller 50 causes envelope-modulation signal generator 110 to generate an envelope-modulation signal S_{ME}, which drives the second optical modulator 20. The RF-modulated light 201 then passes through second modulator 20 and is modulated thereby based on envelop-modulation signal S_{ME}. This signal causes the second optical modulator 20 to impart a modulation envelope A(t) to light 201, thereby forming a twice-modulated optical RF pulse 202 having the wavepacket form as shown in FIG. 1. Optical RF pulse 202 is then detected by photodetector 30, which converts the optical pulse into an electrical RF pulse S_{P}. In an example embodiment, controller 50 gates photodetector 30 via a gating signal S₃₀. Pulse S_{P} is then transmitted over cable 40 to an external device D, as shown. In an example embodiment, device D is configured for holding elements (e.g., one or more atoms, one or more ions, etc.) that can be place in a quantum state to form a quantum bit or “qubit.” In an example embodiment, device D is or includes an ion trap or an atom trap.

Because RF pulse generator system 10 is highly linear, phase and amplitude distortions are essentially eliminated. Thus, the phase φ of RF pulse S_{P} is precisely imparted with very little or no substantial phase error Δφ. In an example embodiment, the phase error Δφ can be kept to below 0.1°, or even 0.01°. This includes reducing or eliminating random or quasi-random phase errors that give rise to jitter in the electrical RF pulse. Thus, RF pulse generator system 10 can be said to generate low-jitter electrical RF pulses.

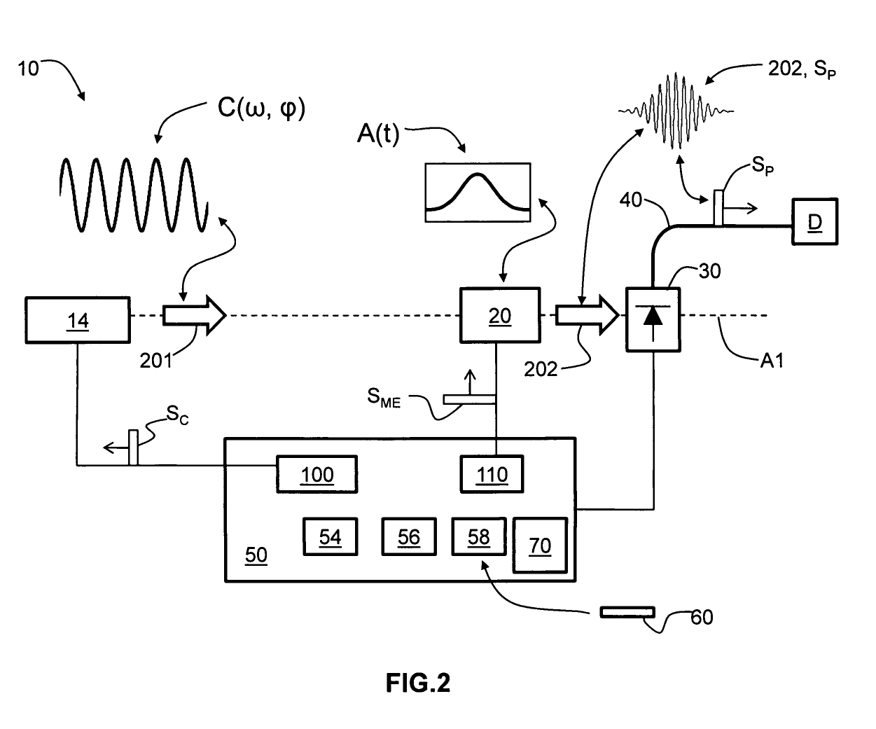

FIG. 2 is a schematic diagram of a second example embodiment of the RF pulse generator system 10 similar to that shown in FIG. 1, except that the system only uses one optical modulator 20, which is used to impart the modulation envelope. With reference to FIG. 2, carrier-signal generator 100 sends carrier signals S_{C} to laser 14 so as to cause the laser to directly generate RF-modulated laser light 201 having the same carrier frequency ω and phase φ as the electrical carrier signal S_{C}. In this case, the electrical carrier signal S_{C} also serves the same role as laser control signal S₁₄, e.g., the two signals can be considered as being combined. Otherwise, system 10 of FIG. 2 operates in the same manner as system 10 of FIG. 1 as described above.

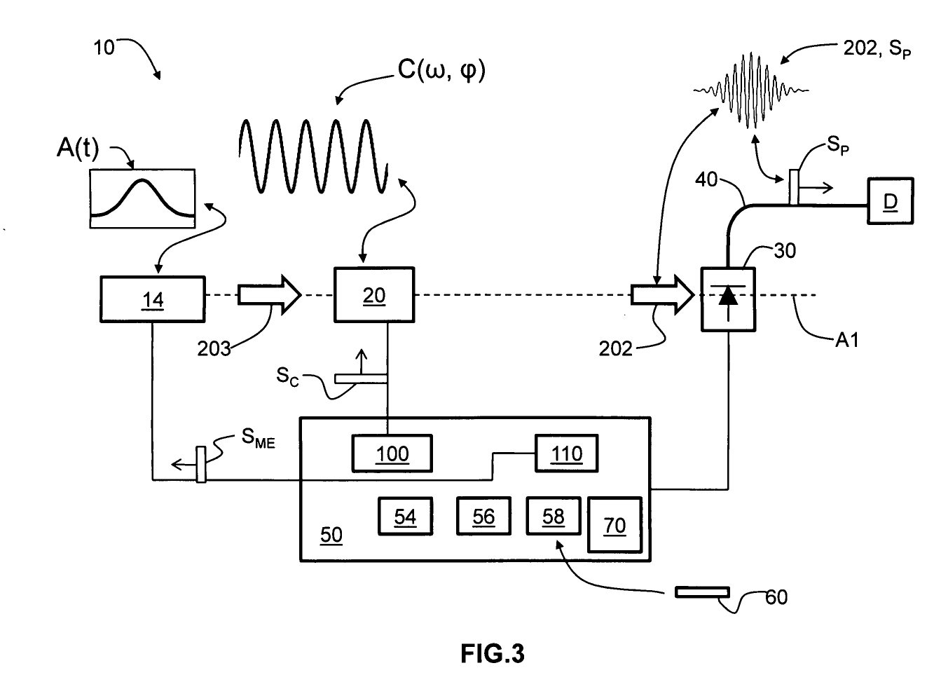

FIG. 3 is a schematic diagram of a third example embodiment of the RF pulse generator system 10 similar to that shown in FIG. 2, except that the system only uses one optical modulator 20, which is used to impart the carrier modulation. With reference to FIG. 3, envelop-modulation generator 110 sends envelop-modulation signals SME to laser 14 so as to cause the laser to directly generate once-modulated envelope-modulated laser light 203. This light is then carrier-modulated by modulator 20, as described above, to form the twice-modulated optical RF pulse 202. In this case, electrical envelope-modulation signal S_{ME} also serves the same role as laser control signal S₁₄, e.g., the two signals can be considered as being combined.

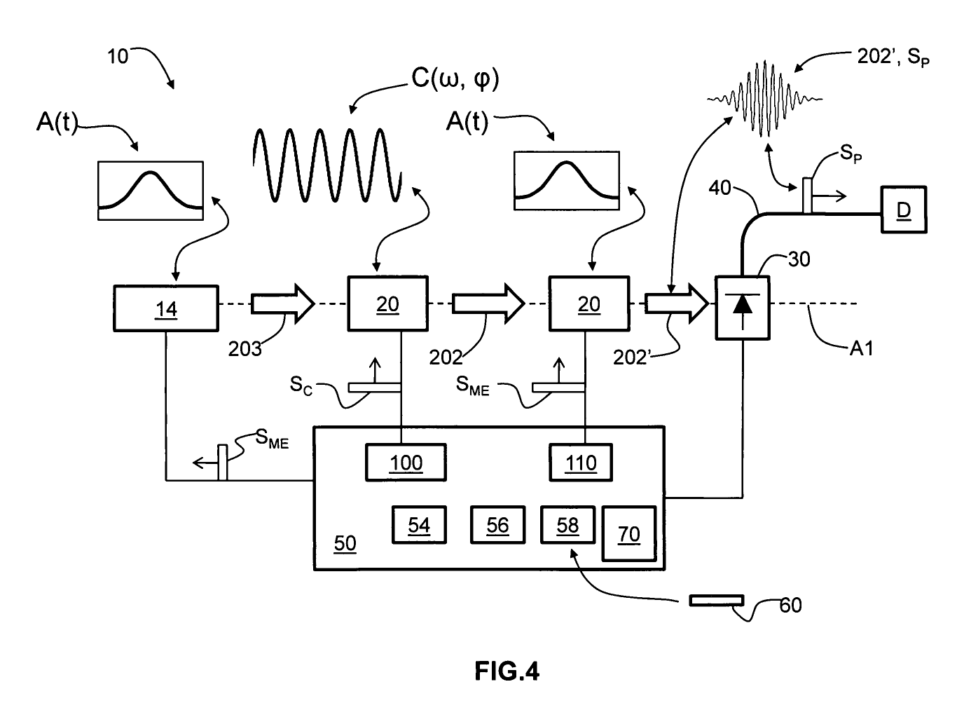

FIG. 4 is a schematic diagram similar to that of FIG. 1 and FIG. 3 and illustrates a fourth example embodiment of the RF pulse generator system 10 wherein the system uses two optical modulators 20 as described in connection with FIG. 1, but wherein the controller also envelope-modulates laser 14 directly as described above in connection with FIG. 3. This embodiment applies the envelope modulation twice to the optical signal—once when the signal is generated by the laser, and then again downstream of the carrier modulation. This provides a triple-modulated optical RF pulse 202′, which forms an enhanced electrical RF pulse S_{P} having an enhanced extinction ratio (i.e., Power on/Power off).

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A radio-frequency (RF) pulse generator system comprising:
a laser that emits laser light;
a first optical modulator arranged to receive the laser light, and configured to impart to the received laser light one of an envelope modulation and a carrier modulation;
a second optical modulator arranged downstream of the first optical modulator so as to receive the laser light from the first modulator, and configured to impart to the laser light therefrom the other of the carrier modulation and the envelope modulation imparted by the first modulator so as to form an optical RF pulse; and
a photodetector arranged to receive and detect the optical RF pulse from the second modulator and form a corresponding RF electrical pulse.

2. The system of claim 1, further including an electrical cable connected to the photodetector so as to carry the RF electrical pulse.

3. The system of claim 1, further including an external device connected to the electrical cable, the external device adapted to receive the RF electrical pulse.

4. The system of claim 3, wherein the external device is or includes an ion trap or an atom trap capable of forming one or more qubits.

5. The system of claim 1, further including:
an envelope-modulation generator that generates an envelope-modulation signal and that is operably connected to the first or second modulator so as to provide said envelope-modulation signal thereto so as to drive the first or second modulator.

6. The system of claim 1, further including:
a carrier-modulation generator that generates a carrier-modulation signal and that is operably connected to the other of the first or second modulator so as to provide said carrier-modulation signal thereto to drive said first or second modulator.

7. The system of claim 5, wherein the envelope-modulation generator is electrically connected to the laser and provides the envelope-modulation signal thereto so as to impart an envelope modulation to the laser light emitted by the laser.

8. A radio-frequency (RF) pulse generator system comprising:
a laser that emits laser light;
an optical modulator arranged to receive the laser light, and configured to impart to the received laser light one of an envelope modulation and a carrier modulation;
an envelope-modulation generator operably connected to one of the laser and the optical modulator and configured to generate an envelope-modulation signal that drives one of the laser and the optical modulator with the envelope modulation;
a carrier-modulation generator operably connected to the other of the laser and the optical modulator and configured to generate a carrier modulation signal that drives with the carrier modulation the other of the laser and the optical modulator driven by the envelope-modulation generator so that the laser light exiting the optical modulator includes an envelope modulation and a carrier modulation that forms an optical RF pulse; and
a photodetector arranged to receive the optical RF pulse and form therefrom a corresponding electrical RF pulse.

9. The system of claim 8, wherein the envelope-modulation generator is connected to the laser, and the carrier-modulation generator is connected to the optical modulator.

10. The system of claim 8, further including an electrical cable electrically connected to the photodetector so as to carry the RF electrical pulse.

11. The system of claim 10, further including an external device electrically connected to the electrical cable and adapted to receive the RF electrical pulse.

12. The system of claim 11, wherein the external device is or includes an ion trap or an atom trap capable of forming at least one qubit.

13. A method of generating an electrical RF pulse, comprising:
a) generating laser light;
b) imparting an envelope modulation to the laser light;
c) imparting a carrier modulation to the laser light; and
d) detecting the envelope-modulated and carrier-modulated light, thereby forming the electrical RF pulse.

14. The method of claim 13, including imparting the carrier modulation to the laser light prior to imparting the envelope modulation.

15. The method of claim 13, including providing the electrical RF pulse to an external device.

16. The method of claim 15, wherein the external device includes an ion trap or an atom trap responsive to the electrical RF pulse.

17. The method of claim 13, including:
generating the laser light from a laser; and
imparting one of the envelope modulation and the carrier modulation by providing a corresponding envelope-modulation signal or a carrier-modulation signal to the laser so that the laser light outputted by the laser is modulated.

18. The method of claim 13, further comprising carrying out one or more of acts a) through d) under the operation of a processor that executes processor-readable instructions as embodied in a processor-readable medium.

19. The method of claim 13, wherein the electrical RF signal has a phase error Δφ<0.1 degree.

20. The method of claim 19, wherein the phase error Δφ<0.01 degree.
